(19) United States
(12) Patent Application Publication
(10) Pub. No.: US 2026/0301028 A1
(43) Pub. Date: Oct. 1, 2026

(54) ADVERTISEMENT CONTENT GENERATION DEVICE, ADVERTISEMENT CONTENT GENERATION METHOD, AND RECORDING MEDIUM

(71) Applicant: NEC Corporation, Tokyo (JP)

(72) Inventors: Daisuke MATSUDA, Tokyo (JP); Muneyuki HAMABE, Tokyo (JP); Shintaro SOMA, Tokyo (JP)

(73) Assignee: NEC Corporation, Tokyo (JP)

(21) Appl. No.: 19/578,132

(22) Filed: Mar. 25, 2026

(30) Foreign Application Priority Data
Mar. 31, 2025 (JP) 2025-057841

(51) Int. Cl. G06Q 30/0241

(52) U.S. Cl. CPC G06Q 30/0276

(57) ABSTRACT

An advertisement content generation device includes, at least one memory storing instructions, and at least one processor configured to execute the instructions to, receive advertisement content generation target information, generate a prompt based on the advertisement content generation target information, and input the prompt to a machine learning model that refers to a database including at least data related to media content to generate advertisement content. Furthermore, the apparatus leverages AI-based decision making to determine whether the generated advertising content complies with preset criteria before presentation.

This application is based upon and claims the benefit of priority from Japanese Patent Application No. 2025-057841, filed on Mar. 31, 2025, the disclosure of which is incorporated herein in its entirety by reference.

### TECHNICAL FIELD

The present disclosure relates to an advertisement content generation device, an advertisement content generation method, and a recording medium.

### BACKGROUND ART

JP 2021-140228 A describes a system that generates text of a plurality of advertisements based on text that is a basis of an advertisement and a keyword related to the advertisement, estimates an advertisement effect of the generated text of the plurality of advertisements, and regenerates text of a new advertisement from the text of the plurality of advertisements based on the estimated advertisement effect.

### SUMMARY

JP 2021-140228 A does not disclose generating advertisement text according to a current situation. An aspect of the present disclosure has been made in view of the above problem, and an object of the present disclosure is to generate more effective advertisement content according to the current situation.

An aspect of an advertisement content generation device includes a reception unit that receives advertisement content generation target information, a prompt generation unit that generates a prompt based on the advertisement content generation target information, and an advertisement content generation control unit that inputs the prompt to a machine learning model that refers to a database including at least data related to media content to generate advertisement content.

An aspect of an advertisement content generation method executed by at least one processor includes receiving advertisement content generation target information, generating a prompt based on the advertisement content generation target information, and inputting the prompt to a machine learning model that refers to a database including at least data related to media content to generate advertisement content.

An aspect of a non-transitory recording medium recording a program for causing a computer to execute the processing of, receiving advertisement content generation target information, generating a prompt based on the advertisement content generation target information, and inputting the prompt to a machine learning model that refers to a database including at least data related to media content to generate advertisement content.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration of an advertisement content generation device according to the present disclosure;

FIG. 2 is a flowchart illustrating a flow of advertisement content generation according to the present disclosure;

FIG. 3 is a block diagram illustrating a configuration of an advertisement content generation device according to the present disclosure;

FIG. 4 illustrates a screen example according to the present disclosure;

FIG. 5 illustrates a screen example according to the present disclosure;

FIG. 6 illustrates a screen example according to the present disclosure;

FIG. 7 is a flowchart illustrating a flow of an advertisement content generation method according to the present disclosure; and

FIG. 8 is a block diagram illustrating a configuration of a computer that functions as an advertisement content generation device according to the present disclosure.

### EXAMPLE EMBODIMENT

Hereinafter, example embodiments of the present disclosure will be exemplified. However, the present disclosure is not limited to the following illustrative example embodiments, and various modifications may be made within the scope described in the claims. For example, example embodiments obtained by appropriately combining techniques (some or all of objects or methods) used in the following illustrative example embodiments may fall within the scope of the present disclosure. Example embodiments obtained by appropriately omitting some of the techniques used in the following illustrative example embodiments may fall within the scope of the present disclosure. Effects mentioned in the following illustrative example embodiments are examples of effects expected in the illustrative example embodiments, and do not define extension of the present disclosure. That is, example embodiments that do not exert the effects mentioned in the following illustrative example embodiments may fall within the scope of the present disclosure.

### FIRST EXAMPLE EMBODIMENT

### Overall configuration

In the first example embodiment, an advertisement content generation device that generates advertisement content based on accurate information by referring to media content will be described.

### Functional configuration

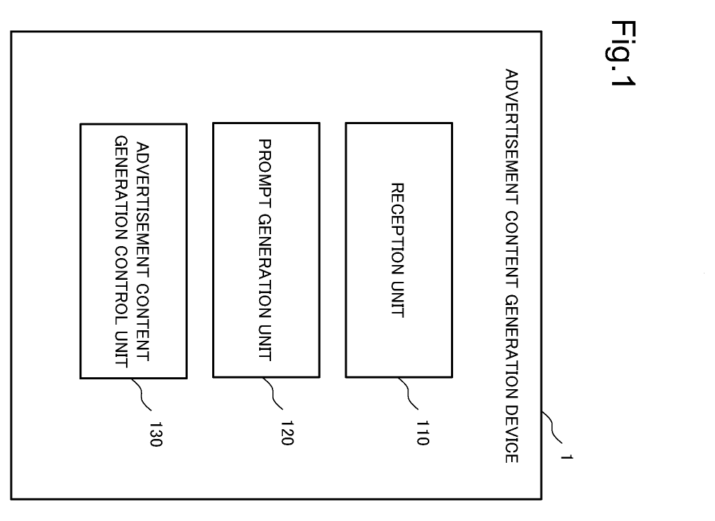

FIG. 1 is a block diagram illustrating a configuration of an advertisement content generation device 1. The advertisement content generation device 1 includes a reception unit 110, a prompt generation unit 120, and an advertisement content generation control unit 130.

The reception unit 110 receives the advertisement content generation target information. The reception unit 110 may receive the advertisement content generation target information from the recording device. Alternatively, advertisement content generation target information input via a device used by the user may be received.

The advertisement content generation target information is information including at least one piece of basic information (advertisement target product, service, company, etc.) that is a target of advertisement content generation and other peripheral information (advertisement target product features, target information, etc.).

The basic information is basic data related to a product, a service, a company, or the like that is an advertisement target. For example, the basic information is information such as an outline of an advertisement target product, a target customer, a providing region, and a product lineup.

The peripheral information is accompanying information related to a target of advertisement content generation. Examples of the peripheral information include a feature of an advertisement target product provided by an advertisement orderer, a desired advertisement expression, an expression to be avoided, an image or a video that should be used, details of a target customer, past advertisement achievement (a click rate, a conversion rate, or the like), a brand guideline, an access history of an advertisement posting site, and trend information.

The prompt generation unit 120 generates a prompt based on the advertisement content generation target information received by the reception unit 110. Specifically, for example, the prompt generation unit 120 generates a prompt by incorporating advertisement content generation target information into a predetermined template. The prompt is a statement to be input to a generation model to be described later. For example, the prompt is text in a natural language including the advertisement content generation target information. The prompt generation unit 120 outputs a prompt based on the advertisement content generation target information to the advertisement content generation control unit 130.

The advertisement content generation control unit 130 receives the prompt generated by the prompt generation unit 120 as an input, and generates the advertisement content using a machine learning model (generation model) that refers to a database including data related to the media content. The database includes data related to media content, and includes media content such as, for example, newspaper articles, economic and financial data, industry reports, academic papers, social media data, government publication data, patent information, market research reports, and the like. The database may include specific features of the advertisement content target product, trend information of the industry, and the like. A search extension generation technique such as retrieval-augmented generation (RAG) may be used to refer to the database. As a result, it is possible to reflect media content not included in the learning data of the generation model or detailed information about a specific domain in the answer.

The advertisement content is content generated for the purpose of advertising a particular product or service, brand, or business. The format of the content is text, an image, a moving image, audio, or another media format, and may be a combination of a plurality of media formats. The machine learning model is any machine learning model, and may be, for example, a large-scale language model, a time series prediction model, a multimodal model, or the like. For example, in a case where both the input prompt and the output answer are text data of a natural language, a language model that has learned a natural language may be applied as the generation model. Learning a natural language more specifically means learning an arrangement of components (words and the like) in a sentence in a natural language or an arrangement of a sentence and a sentence in text. Examples of such a language model include bidirectional encoder representations from transformers (BERT), robustly optimized BERT approach (RoBERTa), efficiently learning an encoder that classifies token replacements accurately (ELECTRA), and the like. The generation model may be obtained by fine-tuning a general-purpose generation model in such a way that information necessary for generating advertisement content is generated with high accuracy. In the fine tuning, data including a set of a prompt and an answer to be generated for the prompt may be used as the training data.

Note that the machine learning model may be stored in the advertisement content generation device 1 or may be stored in another device. In the latter case, the advertisement content generation control unit 130 may transmit a prompt to another device and cause the another device to generate an answer, and may acquire the generated answer from the other device. The database may be included in the advertisement content generation device 1 or may be connected outside the advertisement content generation device 1.

As described above, the advertisement content generation device 1 according to the present illustrative example embodiment employs a configuration including the reception unit 110 that receives advertisement content generation target information, the prompt generation unit 120 that generates a prompt based on the advertisement content generation target information, and the advertisement content generation control unit 130 that generates advertisement content by inputting the prompt to a machine learning model that refers to a database including at least data related to media content.

According to the above configuration, since the advertisement content generation device 1 generates the advertisement content based on the media content indicating the current state such as the newspaper article and the reliable report stored in the database, the advertisement content generation device 1 has an effect of generating more effective advertisement content according to the current situation.

### Advertisement content generation program

The above-described functions of the advertisement content generation device 1 can also be implemented by a program. An advertisement content generation program according to the present illustrative example embodiment causes a computer to function as a reception means for receiving advertisement content generation target information, a prompt generation means for generating a prompt based on the advertisement content generation target information, and an advertisement content generation control means for inputting the prompt to a machine learning model that refers to a database including at least data related to media content to generate advertisement content. This advertisement content generation program has an effect of generating more effective advertisement content according to the current situation.

### Flow of advertisement content generation method

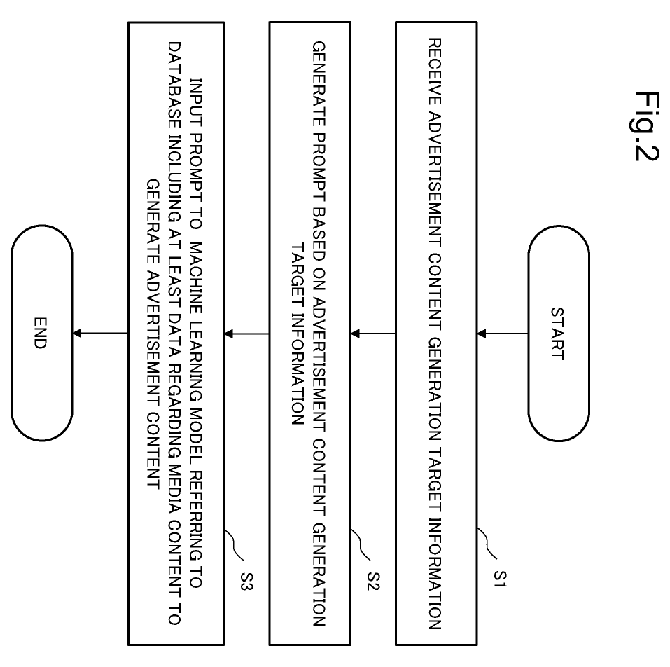

A flow of advertisement content generation according to the present illustrative example embodiment will be described with reference to FIG. 2. FIG. 2 is a flowchart illustrating a flow of an advertisement content generation method. The execution entity of each step in this advertisement content generation method may be a processor included in the advertisement content generation device 1, may be a processor included in another device, or may be a processor in which the execution entities of respective steps are provided in different devices.

In S1 (reception process), at least one processor receives advertisement content generation target information.

In S2 (prompt generation process), at least one processor generates a prompt based on the advertisement content generation target information received in S1.

In S3 (advertisement content generation control process), at least one processor inputs the prompt generated in S2 to a machine learning model that refers to a database including at least data related to media content, and generates an answer for generating advertisement content.

As described above, the advertisement content generation method according to the present illustrative example embodiment employs a configuration including a reception process of receiving advertisement content generation target information, a prompt generation process of generating a prompt based on the advertisement content generation target information, and an advertisement content generation control process of generating advertisement content by inputting the prompt to a machine learning model that refers to a database including at least data related to media content. Therefore, according to the above configuration, the advertisement content generation method has an effect of generating more effective advertisement content according to the current situation.

The execution entity of each process described in the above-described illustrative example embodiments is optional, and is not limited to the above-described examples. For example, a system having a function similar to that of the advertisement content generation device 1 can be constructed by a plurality of devices capable of communicating with each other. The execution entity of each process illustrated in the flowchart illustrated in FIG. 2 may be one device (also referred to as a processor) or a plurality of devices (also referred to as a processor).

### Second example embodiment

A second example embodiment, that is an example of the example embodiments of the present disclosure, will be described in detail with reference to the drawings. Components having the same functions as the components described in the illustrative example embodiment described above will be denoted by the same reference signs, and description of the components will be appropriately omitted. An application range of each of techniques used in the present illustrative example embodiment is not limited to the present illustrative example embodiment. That is, each technique used in the present illustrative example embodiment can also be used in another illustrative example embodiment included in the present disclosure within a range in which no particular technical problem occurs. Each technique illustrated in each of the drawings referred to for describing the present illustrative example embodiment can be employed in the other illustrative example embodiments included in the present disclosure within the scope in which no particular technical problem occurs.

### Configuration of advertisement content generation device 1A

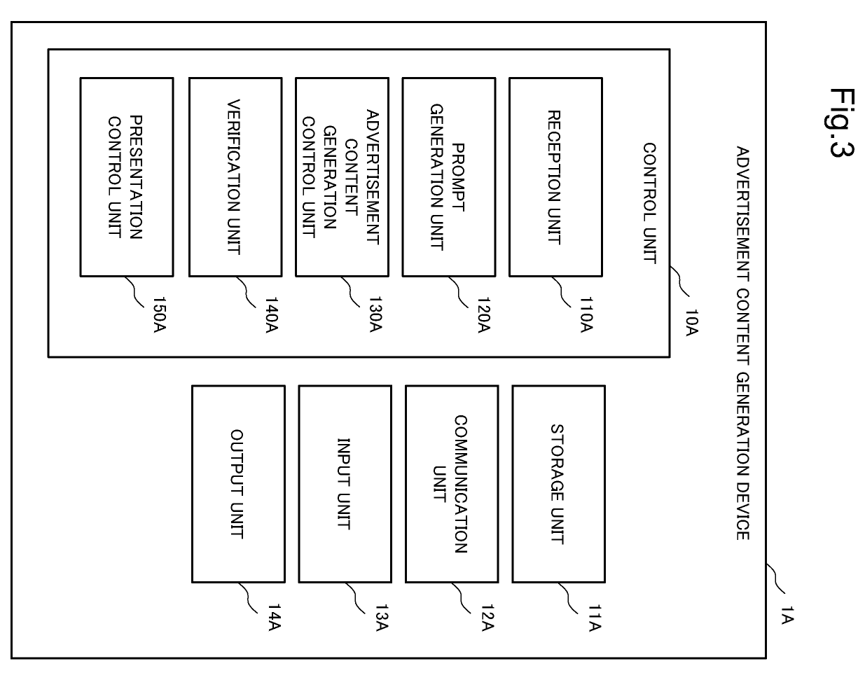

A configuration of an advertisement content generation device 1A according to the second example embodiment will be described with reference to FIG. 3. FIG. 3 is a block diagram illustrating a configuration of an advertisement content generation device 1A. Advertisement content generation device 1A is a device having an advertisement content generation function of generating advertisement content. The advertisement content generation device 1A may be a local device used by individual users, or may be a server that provides advertisement content generation services to a plurality of users.

As illustrated in FIG. 3, the advertisement content generation device 1A includes a control unit 10A that integrally controls each unit of the advertisement content generation device 1A, and a storage unit 11A that stores various pieces of data used by the advertisement content generation device 1A. The advertisement content generation device 1A includes a communication unit 12A for the advertisement content generation device 1A to communicate with another device, an input unit 13A that receives an input to the advertisement content generation device 1A, and an output unit 14A for the advertisement content generation device 1A to output data. The control unit 10A includes a reception unit 110A, a prompt generation unit 120A, an advertisement content generation control unit 130A, a verification unit 140A, and a presentation control unit 150A.

The reception unit 110A, the prompt generation unit 120A, and the advertisement content generation control unit 130A have the same configurations as the reception unit 110, the prompt generation unit 120, and the advertisement content generation control unit 130 of the first example embodiment, respectively, and the description thereof will be omitted.

The verification unit 140A verifies whether the content of the advertisement content generated by the advertisement content generation control unit satisfies a predetermined criterion, and outputs a verification result to the presentation control unit 150A. Specifically, for example, the verification unit 140A verifies whether the content of the advertisement content satisfies a rule set in advance as a predetermined criterion. The rule set in advance indicates, for example, whether a predetermined keyword or an expression (discriminatory expression, possibly misleading language, legally problematic language, etc.) evoking the keyword is included in the advertisement content.

The verification unit 140A may verify whether the advertisement content satisfies a predetermined criterion based on the media content stored in the database. Specifically, for example, the verification unit 140A calculates an index indicating a degree of whether the advertisement content is based on the media content, and verifies whether the calculated index satisfies a predetermined criterion. The index is calculated by Retrieval Augmented Generation (RAG). Specifically, the verification unit 140A uses the advertisement content as a query, and extracts part of the media content using the query. Next, the verification unit 140A calculates similarity between the extracted media content and the query (advertisement content). Finally, the verification unit 140A verifies whether the index, which is the calculated similarity, satisfies a predetermined criterion. The rule used by the verification unit 140A, the keyword list, and the machine learning model may be stored in the advertisement content generation device 1A or may be stored in another device.

The presentation control unit 150A controls the presentation of the advertisement content generated by the advertisement content generation control unit 130A based on the verification result input from the verification unit 140A. “Presentation” means that the user (for example, a person who designates an advertisement content generation target) can recognize the presentation content. Specifically, for example, in a case where the verification result indicates that the advertisement content satisfies the predetermined criterion, the presentation control unit 150A displays the advertisement content on the display device. As a result, the user can recognize the advertisement content displayed on the display device. For example, the presentation control unit 150A may perform control to upload advertisement content to a server accessible by the user. As a result, the user can access the server and recognize the advertisement content uploaded by the presentation control unit 150A.

As described above, the advertisement content generation device 1A according to the second example embodiment employs a configuration including the reception unit 110A that receives advertisement content generation target information, the prompt generation unit 120A that generates a prompt based on the advertisement content generation target information, and the advertisement content generation control unit 130A that generates advertisement content by inputting the prompt to a machine learning model that refers to a database including at least data related to media content. Therefore, as in the advertisement content generation device 1, the advertisement content generation device 1A has an effect of generating more effective advertisement content according to the current situation.

As described above, the advertisement content generation device 1A includes the verification unit 140A that verifies whether the content of the advertisement content generated by the advertisement content generation control unit 130A satisfies a predetermined criterion. The advertisement content generation device 1A includes the presentation control unit 150A that performs control to present the advertisement content in a case where the verification unit 140A verifies that the predetermined criterion is satisfied. As a result, in addition to the effect that the advertisement content generation device 1 according to the first example embodiment has, an effect of preventing advertisement content not satisfying the predetermined criterion from being presented can be obtained.

### Modification of second example embodiment

Hereinafter, as a modification of the second example embodiment, an example embodiment of each configuration unit that reflects feedback (for example, a correction request or a request for additional information) from the user in the advertisement content presented by the presentation control unit 150A will be described. Specifically, for example, the reception unit 110A receives feedback of a natural language input via a device used by the user, and outputs the feedback to the prompt generation unit 120A. The prompt generation unit 120A generates a prompt reflecting a correction request or a request for additional information indicated by the feedback input from the reception unit 110A using the language model that has learned the natural language. For example, the prompt generation unit 120A generates a prompt indicating an instruction regarding content correction of advertisement content. The advertisement content generation control unit 130A generates the advertisement content reflecting the feedback using the prompt newly generated by the prompt generation unit 120A.

The feedback may be not only a partial sentence correction but also an instruction to reconstruct the concept or design of the entire advertisement. Specifically, for example, the user instructs a concept change (for example, “emphasize a particular point of appeal more”) of the entire advertisement as feedback. In this case, the above-described processing of the prompt generation unit 120A and the advertisement content generation control unit 130A generates the advertisement content whose entire configuration is corrected in accordance with the instruction.

With the present feedback function, it is possible for the user to interactively use the advertisement content generation device 1A, and the example embodiment has an effect of being able to generate an advertisement more suitable for the user's needs and intention.

### Reception screen example

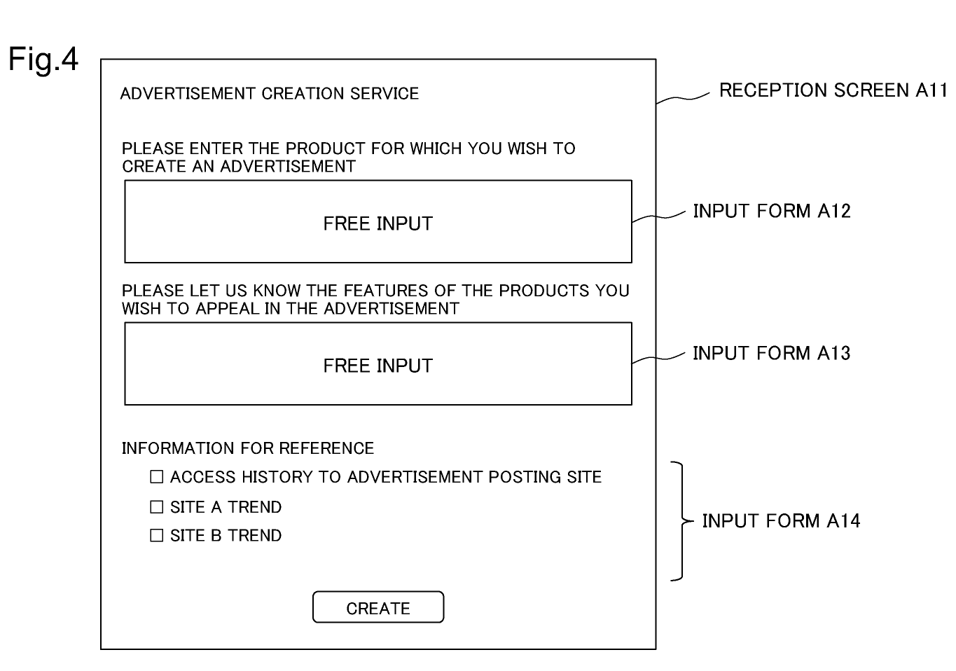

FIG. 4 is a diagram illustrating a reception screen for the reception unit 110A to receive the advertisement content generation target information. The reception unit 110A may receive information from the user via a reception screen A11 illustrated in FIG. 4. As illustrated in FIG. 4, the reception screen A11 includes an input form A12, an input form A13, and an input form A14.

For example, in the input form A12, an answer of the user to a question “Please enter the product for which you wish to create the advertisement” is input. In the input form A13, an answer of the user to a question “Please let us know the features of the product you wish to appeal in the advertisement” is input. The input form A14 is a check box for selecting information to be referred to. The user selects information to be referred to from the information illustrated in the input form A14 using the check box. The reception unit 110A receives information input or selected in the input forms A12, A13, and A14 as advertisement content generation target information.

### Screen example presented by presentation control unit

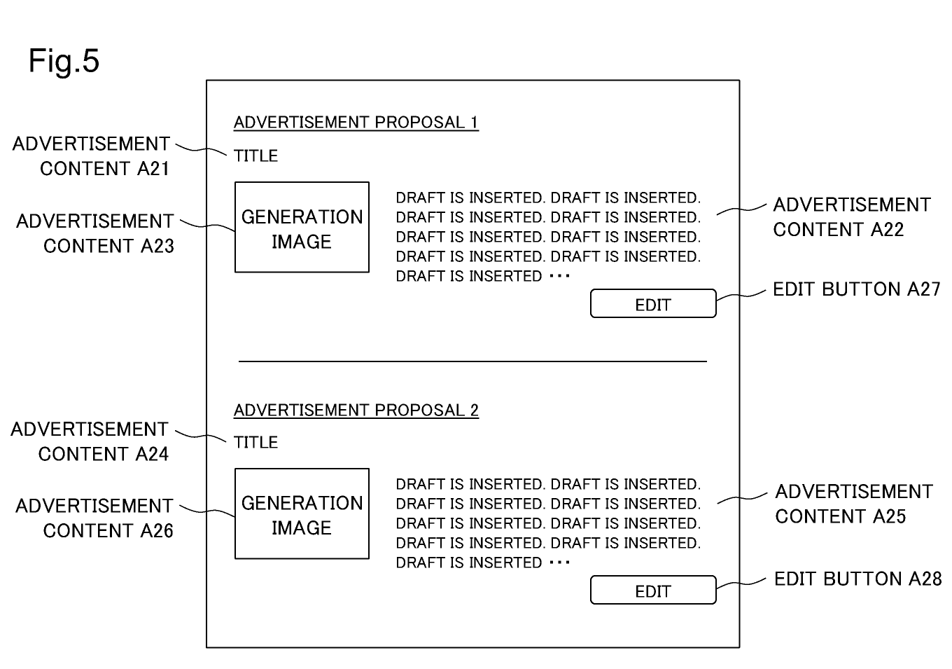

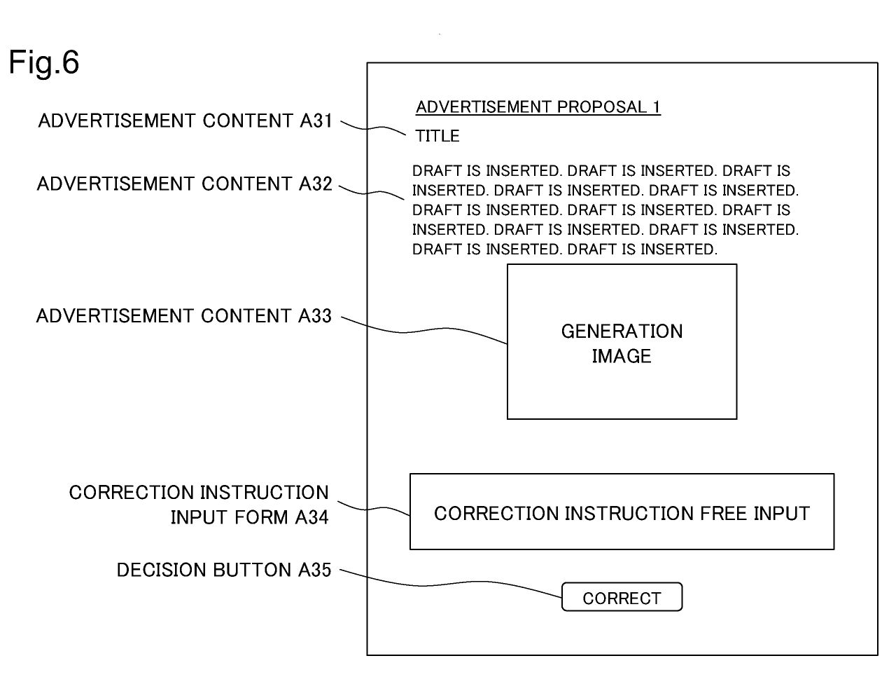

FIG. 5 is a diagram illustrating a screen example presented by the presentation control unit 150A. On the screen illustrated in FIG. 5, advertisement content A21, advertisement content A22, and advertisement content A23 are displayed as an advertisement proposal 1, advertisement content A24, advertisement content A25, and advertisement content A26 are displayed as an advertisement proposal 2, and an edit button A27 and an edit button A28 are displayed for each advertisement proposal. The advertisement content A21 and the advertisement content A24 indicate an advertisement title. The advertisement content A22 and the advertisement content A25 are advertisement content indicated by text. The advertisement content A23 and the advertisement content A26 are advertisement content indicated by images. The edit buttons A27 and A28 are buttons for transitioning to a feedback input screen (described later with reference to FIG. 6) for each related content.

### Feedback screen example

FIG. 6 is a diagram illustrating a feedback screen displayed when the user clicks any of the edit buttons A27 and A28 illustrated in FIG. 5.

As illustrated in FIG. 6, the feedback screen includes, for example, advertisement content A31, A32, and A33 to be fed back, a correction instruction input form A34, and a decision button A35. For example, in a case where the edit button A27 illustrated in FIG. 5 is clicked, the advertisement content A21, A22, and A23 are displayed for the advertisement content A31, A32, and A33 of FIG. 6.

The correction instruction input form A34 is a form in which the user inputs feedback on the advertisement content. For example, the user inputs a correction or addition instruction such as “I want to soften the tone a little more” or “Please emphasize the word cherry” in the correction instruction input form A34 in a free description format. When the user clicks the decision button A35 after the input to the correction instruction input form A34, the presentation control unit 150A outputs the feedback content to the reception unit 110A. The prompt generation unit 120A generates a prompt based on the feedback received by the reception unit 110A, and outputs the prompt to the advertisement content generation control unit 130A. The advertisement content generation control unit 130A generates the advertisement content reflecting the feedback based on the prompt generated by the prompt generation unit 120A. As a result, the advertisement content generation device 1A can generate an advertisement reflecting the user's desire more.

### Flow of process

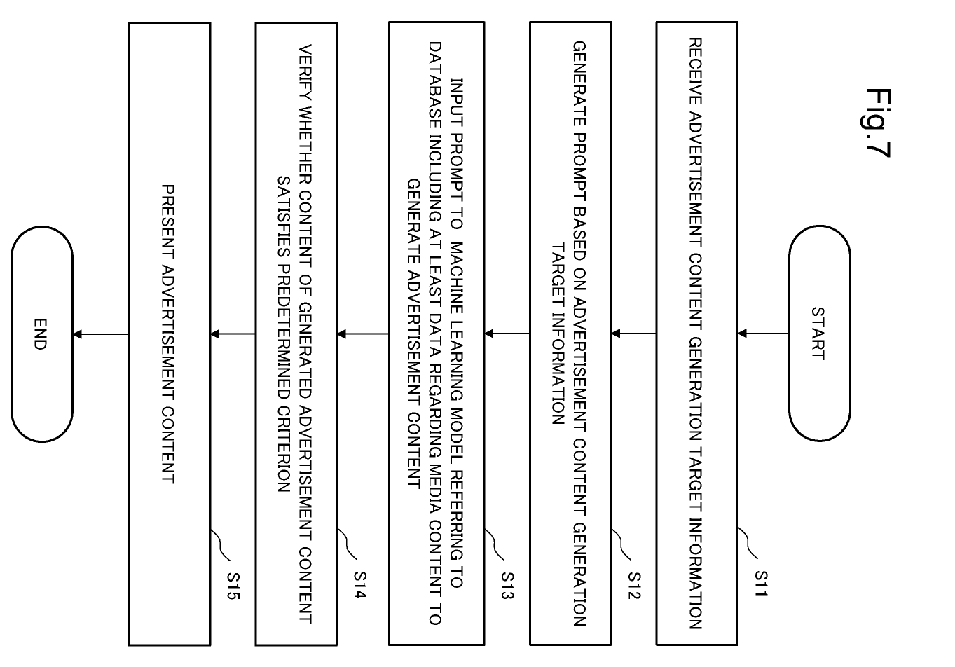

A flow of an advertisement content generation method according to the second example embodiment will be described with reference to FIG. 7. FIG. 7 is a flowchart illustrating a flow of an advertisement content generation method. The execution entity of each step in this advertisement content generation method may be a processor included in the advertisement content generation device 1, may be a processor included in another device, or may be a processor in which the execution entities of respective steps are provided in different devices.

In S11 (reception process), at least one processor receives the advertisement content generation target information.

In S12 (prompt generation process), at least one processor generates a prompt based on the advertisement content generation target information received in S11.

In S13 (advertisement content generation control process), at least one processor inputs the prompt generated in S12 to a machine learning model that refers to a database including at least data related to media content, and causes the machine learning model to generate advertisement content.

In S14 (verification process), at least one processor verifies whether the content of the advertisement content generated in S13 satisfies a predetermined criterion.

In S15 (presentation control process), at least one processor presents the advertisement content generated in S13.

As described above, the advertisement content generation method according to the second example embodiment employs a configuration including a reception process of receiving advertisement content generation target information, a prompt generation process of generating a prompt based on the advertisement content generation target information, an advertisement content generation control process of generating advertisement content by inputting the prompt to a machine learning model that refers to a database including at least data related to media content, a verification process of verifying whether content of the advertisement content is appropriate, and a presentation control process of presenting the advertisement content. As a result, in addition to the effect that the first illustrative example embodiment has, an effect that the possibility of presenting advertisement content that does not satisfy the predetermined criterion can be reduced can be obtained.

The execution entity of each process described in the above-described second example embodiment is optional, and is not limited to the above-described example. For example, a system having a function similar to that of the advertisement content generation device 1A can be constructed by a plurality of devices capable of communicating with each other. The execution entity of each process illustrated in the flowchart illustrated in FIG. 7 may be one device (also referred to as a processor) or a plurality of devices (also referred to as a processor).

### Implementation example by software

Some or all of the functions of the advertisement content generation devices 1 and 1A (hereinafter, also referred to as “each of the above devices”) may be implemented by hardware such as an integrated circuit (IC chip) or may be implemented by software.

### Hardware configuration

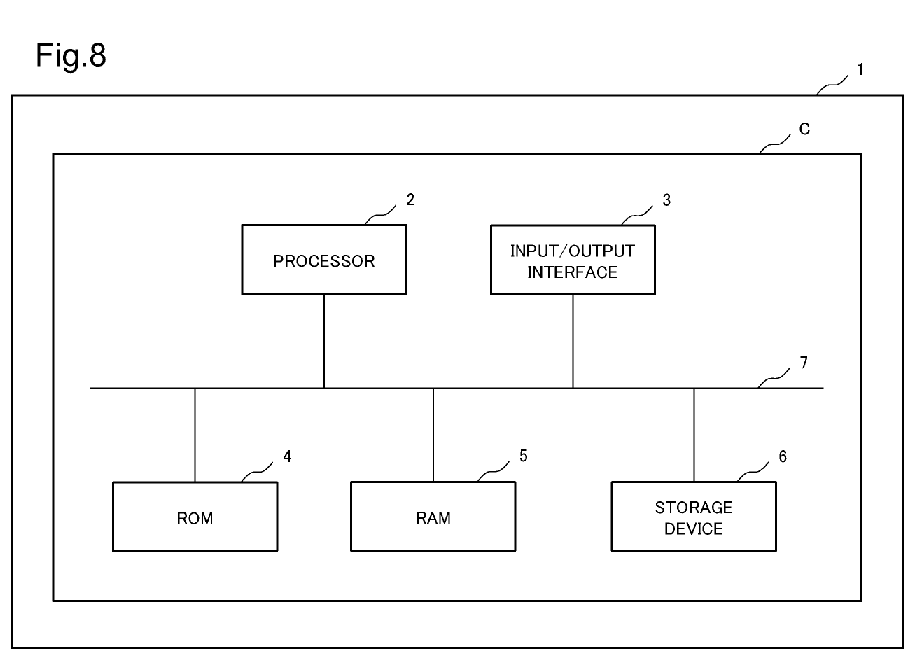

In the latter case, each of the above devices is realized by, for example, a computer C that executes a command of a program that is software for realizing each function. FIG. 8 is a block diagram illustrating a hardware configuration of the advertisement content generation device 1. As illustrated in the drawing, the advertisement content generation device 1 includes a processor 2, an input/output interface 3, a read only memory (ROM) 4, a random access memory (RAM) 5, and a storage device 6. The components are connected to each other through, for example, a bus 7.

The processor 2 is a computer such as a central processing unit (CPU), and controls the entire advertisement content generation device 1 by executing a program prepared in advance. Specifically, it is possible to use, as the processor 2, a CPU, a graphics processing unit (GPU), a digital signal processor (DSP), a micro processing unit (MPU), a floating point number processing unit (FPU), a physics processing unit (PPU), a tensor processing unit (TPU), a quantum processor, a microcontroller, a combination of these, or the like.

The processor 2 loads a program stored in the ROM 4, the storage device 6, or the like. Then, the processor 2 executes each process coded in the program. The processor 2 functions as part or all of the advertisement content generation device 1. The processor 2 may execute the process or the instruction in the flowchart based on the program.

The input/output interface 3 is an interface that connects input/output devices such as a keyboard, a mouse, a display, and a printer.

The ROM 4 stores various programs executed by the processor 2. The RAM 5 is used as a working memory during execution of various processes by the processor 2.

The storage device 6 is a non-volatile non-transitory storage device. For example, the storage device 6 may be a disk-shaped recording medium, a semiconductor memory, or the like. The storage device 6 may be configured to be detachable from the advertisement content generation device 1. The storage device 6 records various programs executed by the processor 2.

Each of the above functions of each of the above devices may be achieved by a single processor provided in a single computer, may be achieved in cooperation with a plurality of processors provided in a single computer, or may be achieved in cooperation with a plurality of processors provided in each of a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Note 1

An advertisement content generation device including

a reception unit that receives advertisement content generation target information,

a prompt generation unit that generates a prompt based on the advertisement content generation target information, and

an advertisement content generation control unit that inputs the prompt to a machine learning model that refers to a database including at least data related to media content to generate advertisement content.

### Supplementary Note 2

The advertisement content generation device according to Supplementary Note 1, wherein the advertisement content includes at least one of text and an image.

### Supplementary Note 3

The advertisement content generation device according to Supplementary Note 1, further including a verification unit that verifies whether content of the advertisement content satisfies a predetermined criterion, and a presentation control unit that performs control to present the advertisement content in a case where the verification unit verifies that the advertisement content satisfies the predetermined criterion.

### Supplementary Note 4

The advertisement content generation device according to Supplementary Note 3, wherein

the reception unit receives feedback for the advertisement content output by the presentation control unit,

the prompt generation unit generates a prompt based on the feedback, and

the advertisement content generation control unit generates advertisement content based on the prompt generated based on the feedback.

### Supplementary Note 5

The advertisement content generation device according to Supplementary Note 1, wherein the advertisement content generation target information includes at least one piece of information about an advertisement target product, target information, and trend information.

### Supplementary Note 6

An advertisement content generation method executed by at least one processor, the method including

receiving advertisement content generation target information,

generating a prompt based on the advertisement content generation target information, and

inputting the prompt to a machine learning model that refers to a database including at least data related to media content to generate advertisement content.

### Supplementary Note 7

An advertisement content generation program for causing a computer to function as

a reception means for receiving advertisement content generation target information,

a prompt generation means for generating a prompt based on the advertisement content generation target information, and

an advertisement content generation control means for inputting the prompt to a machine learning model that refers to a database including at least data related to media content to generate advertisement content.

Some or all of the configurations described in Supplementary Notes 2 to 5 dependent on the above-described Supplementary Note 1 can also be dependent on each of Supplementary Notes 6 to 7 by similar dependency relationship to Supplementary Notes 2 to 5. Some or all of the configurations described as Supplementary Notes can be similarly dependent on not only Supplementary Notes 1, 6, and 7, but also diverse pieces of hardware and software, various recording means for recording software, or systems without departing from the above-described example embodiments.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents.

Further, it is noted that the inventor's intent is to retain all equivalents of the claimed invention even if the claims are amended during prosecution.

1. An advertisement content generation device comprising:
at least one memory storing instructions; and
at least one processor configured to execute the instructions to:
receive advertisement content generation target information;
generate a prompt based on the advertisement content generation target information; and
input the prompt to a machine learning model that refers to a database including at least data related to media content to generate advertisement content.

2. The advertisement content generation device according to claim 1, wherein the advertisement content includes at least one of text and an image.

3. The advertisement content generation device according to claim 1,
wherein the at least one processor is further configured to execute the instructions to:
verify whether content of the advertisement content satisfies a predetermined criterion; and
perform control to present the advertisement content in a case where the advertisement content is verified to satisfy the predetermined criterion.

4. The advertisement content generation device according to claim 3,
wherein the at least one processor is further configured to execute the instructions to:
receive feedback for the output advertisement content,
generate a prompt based on the feedback, and
generate advertisement content based on the prompt generated based on the feedback.

5. The advertisement content generation device according to claim 1, wherein the advertisement content generation target information includes at least one piece of information about an advertisement target product, target information, or trend information.

6. An advertisement content generation method comprising:
by at least one processor,
receiving advertisement content generation target information;
generating a prompt based on the advertisement content generation target information; and
inputting the prompt to a machine learning model that refers to a database including at least data related to media content to generate advertisement content.

7. A non-transitory recording medium recording a program for causing a computer to execute the processing of:
receiving advertisement content generation target information;
generating a prompt based on the advertisement content generation target information; and
inputting the prompt to a machine learning model that refers to a database including at least data related to media content to generate advertisement content.
